(19) United States
(12) Patent Application Publication
(10) Pub. No.: US 2012/0131258 A1
(43) Pub. Date: May 24, 2012

(54) SEMICONDUCTOR MEMORY APPARATUS AND METHOD FOR OPERATING THE SAME

(75) Inventor: Heat Bit PARK, Icheon-si (KR)

(73) Assignee: HYNIX SEMICONDUCTOR INC., Icheon-si (KR)

(21) Appl. No.: 13/217,421

(22) Filed: Aug. 25, 2011

(30) Foreign Application Priority Data
Nov. 18, 2010 (KR) 10-2010-0114793

(51) Int. Cl. G06F 12/06

(52) U.S. Cl. 711/5; 711/E12.085

(57) ABSTRACT

A semiconductor memory apparatus includes, inter alia, a master chip and a plurality of slave chips. Each of the slave chips includes a plurality of banks. A first reception signal, a first timing signal, a bank address signal, and a slice selection signal to the slave chips may be provided by a master chip. The slave chips include a slice determining unit configured to compare the slice selection signal and a slice code and generate a slice enable signal, and a bank selecting unit configured to receive the bank address signal in response to the first reception signal and the slice enable signal and generate a bank enable signal in response to the bank address signal and the first timing signal.

### CROSS-REFERENCES TO RELATED APPLICATION

The present application claims priority under 35 U.S.C. §119(a) to Korean application number 10-2010-0114793, filed on Nov. 18, 2010, in the Korean Intellectual Property Office, which is incorporated herein by reference in its entirety.

### BACKGROUND

1. Technical Field

The present invention relates generally to a semiconductor memory apparatus, and more particularly, to a stacked semiconductor memory apparatus.

2. Related Art

A three-dimensional structure with stacked memory chips known as a stacked semiconductor memory apparatus can improve the integration density and capacity of a semiconductor memory apparatus. Each of the stacked memory chips is called a slice. The types of the three-dimensional structure include, for example, System in Package (SIP), Package on Package (POP), and through-silicon via (TSV).

A TSV structure, as an alternative, can provide solutions to overcome certain weaknesses such as poor data bandwith or the transmission rate degradation related to the distance from the controller on the module or parameters on the package. In a TSV structure, an electrode is formed in a path passing through the stacked memory chips so as to create a communication path between a controller and each memory chip. A stacked semiconductor memory apparatus in a TSV structure may include a master chip and slave chips. The master chip communicates with a controller chip via its input/output unit. The master chip also communicates with the slave chips through the TSV structure with various control signals, timing signals, and data signals in response to the command and address signals from a controller chip.

Unlike a single-layer semiconductor memory apparatus, a stacked semiconductor memory apparatus includes a plurality of slave chips, each having a plurality of banks. Therefore, the stacked semiconductor memory apparatus requires an addressing scheme is that is different from the single-layer semiconductor memory apparatus.

### SUMMARY

In an embodiment of the present invention, a semiconductor memory apparatus includes: a master chip; and a plurality of slave chips each including a plurality of banks, wherein the master chip provides a first reception signal, a first timing signal, a bank address signal, and a slice selection signal to the slave chips, and the slave chips include: a slice determining unit configured to compare the slice selection signal and a slice code and generate a slice enable signal; and a bank selecting unit configured to receive the bank address signal in response to the first reception signal and the slice enable signal and generate a bank enable signal in response to the bank address signal and the first timing signal.

In an embodiment of the present invention, a method for operating a semiconductor memory apparatus includes the steps of: applying a slice selection signal and a first reception signal from a mater chip to a plurality of slave chips; comparing, by each of the slave chips, the slice selection signal and each slice code and generating each slice enable signal; receiving, by the slave chip with the slice enable signal activated, a bank address signal and generating a reception bank signal in response to the first reception signal; applying a first timing signal from the master chip to the slave chips; and selecting one of a plurality of banks of the slave chip according to the reception bank signal and the first timing signal.

### BRIEF DESCRIPTION OF THE DRAWINGS

Features, aspects, and embodiments are described in conjunction with the attached drawings, in which:

FIG. 1 is a diagram illustrating a method for accessing a bank for a read/write operation in a stacked semiconductor memory apparatus using a physical rank addressing (PRA) method;

FIG. 2 is a circuit diagram of a bank selecting unit 200 illustrated in FIG. 1 according to an exemplary embodiment of the present invention;

FIG. 3 is a circuit diagram of a slice determining unit 100 illustrated in FIG. 1 according to an exemplary embodiment of the present invention;

FIG. 4 is a block diagram of a timing signal generating unit 300 illustrated in FIG. 1 according to an exemplary embodiment of the present invention;

FIG. 5 is a diagram illustrating the signal transmission of a stacked semiconductor memory apparatus using a logical rank addressing (LRA) method and the signal transmission of a stacked semiconductor memory apparatus using a physical rank addressing (PRA) method; and

FIG. 6 is a circuit diagram illustrating a rank detecting operation of a stacked semiconductor memory apparatus using a logical rank addressing (LRA) method.

### DETAILED DESCRIPTION

Hereinafter, a semiconductor memory apparatus and a method for operating the same according to exemplary embodiments of the present invention will be described below with reference to the accompanying drawings.

In addition to a bank access method, a rank addressing method for accessing slave chips in a stacked semiconductor memory apparatus will be described first.

The rank addressing method for accessing a plurality of slave chips in a stacked semiconductor memory apparatus include, for example, a logical rank addressing (LRA) method and a physical rank addressing (PRA) method.

The logical rank addressing (LRA) method divides and distributes one rank to a plurality of slices (i.e., not just one slice) and accesses a cell by performing and in the following order of:

selecting a portion of each slice, selecting the slice, and selecting the bank and cell address. For example, in a 4-rank logical rank addressing (LRA) method, four ranks are located in each quadrant of the four slices. The first quadrant of all the slices is set to the first rank, the second quadrant is set to the second rank, the third quadrant is set to the third rank, and the fourth quadrant is set to the fourth rank. To access a cell, the following operations are performed: (a) selecting a rank, for example, selecting the first quadrant; (b) selecting a slice, for example, selecting the third slice; and (c) bank is and address selection to select a cell in the first quadrant of the third slice. That is, the third slice of the first rank is selected, and the bank and address in the selected rank and slice is accessed.

According to the physical rank addressing (PRA) method, one rank is assigned to each slice, and a cell is accessed by selecting the slice and the bank and cell address in the order named. For example, in a 4-rank physical rank addressing (PRA) method, there would be four ranks corresponding to four slices, and the first to fourth slices can be set as the first to fourth ranks, respectively. Then, a cell is accessed by: (1) selecting a rank, for example, the third slice; and (2) selecting the bank and address.

A semiconductor memory apparatus such as a dynamic random access memory (DRAM) apparatus may perform an active operation, a precharge operation, a read operation, and a write operation, among others. The logical rank addressing (LRA) method takes more time to access a cell than the physical rank addressing (PRA) method, because the logical rank addressing (LRA) method requires additional operation(s) such as the operation (a) described above as compared to the physical rank addressing (PRA) method. Thus, the logical rank addressing (LRA) method performs the rank selection operation (for example, selecting the first quadrant) only in an active operation and in a precharge operation. In general, the logical rank addressing (LRA) method does not perform the rank selection operation in a read operation or a write operation, because the read operation and the write operation provide insufficient timing is margin for satisfactorily reaching the product standard, as compared to the active operation and the precharge operation. Thus, in the logical rank addressing (LRA) method, a read operation and a write operation may be performed only in the rank (for example, the first quadrant) that was selected in the active operation and the precharge operation. On the other hand, the physical rank addressing (PRA) method takes less time to access a cell than the logical rank addressing (LRA) method, because the physical rank addressing (PRA) method does not perform the operation (a). Thus, the physical rank addressing (PRA) method can perform the rank selection operation not only in the active operation and the precharge operation but also in the read operation and the write operation. Thus, the physical rank addressing (PRA) method can provide more efficient operational characteristics with respect to all the ranks than the logical rank addressing (LRA) method. For example, the physical rank addressing (PRA) method may perform, after activating all the ranks, a read operation or a write operation on a rank.

Described below are logical and physical addressing methods for accessing a stacked semiconductor memory apparatus in more detail.

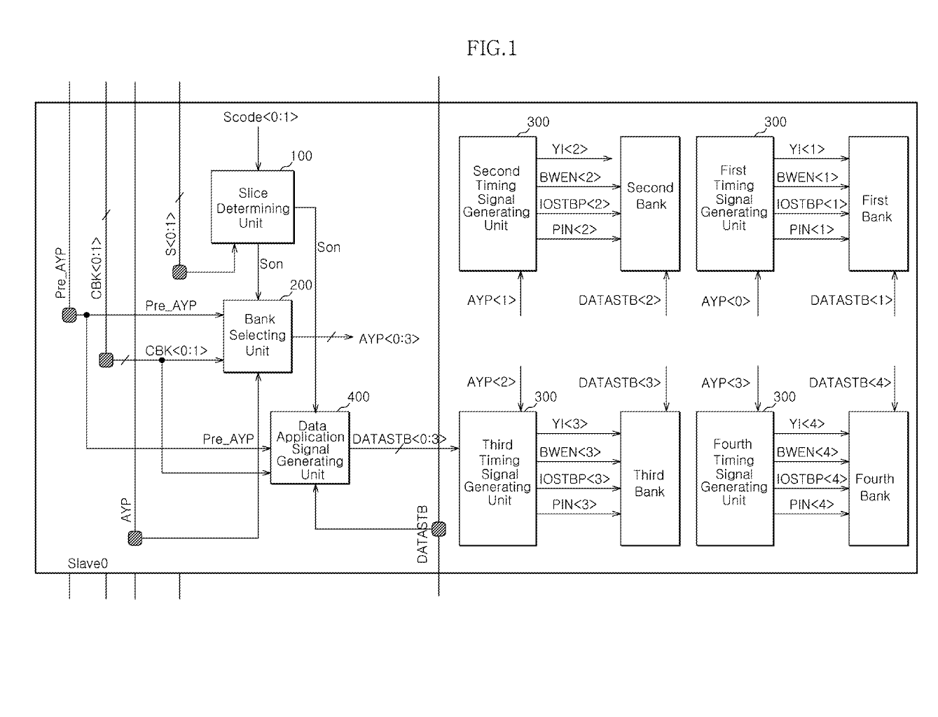

FIG. 1 is a diagram related to describing a physical rank addressing (PRA) method for accessing a bank in a read/write operation in a stacked semiconductor memory apparatus.

Shown in FIG. 1 is one slave chip Slave0 in a stacked semiconductor memory apparatus having a master chip and a plurality of slave chips where each chip includes a plurality of banks.

For example, the slave chip Slave0 will be described with respect to four slave chips Slave0˜Slave3 and four banks (i.e., first to fourth banks) although it should be readily understood that there can be more number of slave chips in the stacked semiconductor memory apparatus and more number of banks in each slave chip.

Referring to FIG. 1, the slave chip Slave0, which uses a physical rank addressing (PRA) method, may include a slice determining unit 100 and a bank selecting unit 200. As described above, the physical rank addressing (PRA) method places one rank in one slice and accesses a desired cell in the slice by a slice selection operation and a bank and cell address selection operation.

The slice determining unit 100 is configured to compare a slice selection signal S<0:1> and an allocated slice code Scode<0:1> and generate a slice enable signal Son. The slice code Scode<0:1> is a unique code of each slave chip. The slice code Scode<0:1> may be stored in the slice determining unit 100, or may be provided by each slice as illustrated in FIG. 1. The slice selection signal S<0:1> is a signal transmitted from the master chip to the slave chips Slave0˜Slave3 through a through-silicon via (TSV) structure. Thus, in the stacked semiconductor memory apparatus having four slave chips Slave0˜Slave3, the slice enable signal Son is activated in the slave chip where the slice selection signal S<0:1> and the slice code Scode<0:1> meet the predetermined criteria (for example, both signals are identical to each other or point to a same slice) for outputting the slice enable signal Son.

The bank selecting unit 200 is configured to receive a bank address signal CBK<0:1> in response to a first reception signal Pre_AYP and the slice enable signal Son and generate a bank enable signal AYP<0:3> in response to the bank address signal CBK<0:1> and a first timing signal AYP. The first reception signal Pre_AYP and the first timing signal AYP are generated by the maser chip, and are transmitted in common to the slave chips Slave0˜Slave3 through a TSV structure. The master chip generates the first reception signal Pre_AYP and the first timing signal AYP upon receiving a read command or a write command from a controller chip. The first reception signal Pre_AYP is activated before the first timing signal AYP. The bank address signal CBK<0:1> has information for determining which bank is selected. The bank address signal CBK<0:1> may be used as a signal obtained by delaying a bank address source signal (not illustrated), which is applied in response to a read command or a write command, by a predetermined time. Also, the bank address signal CBK<0:1> is transmitted in common to the slave chips Slave0˜Slave3 from the master chip.

When the bank enable signal AYP<0:3> is generated by the bank selecting unit 200, the bits of the bank enable signal AYP<0:3> correspond to the banks of the slave chip Slave0 and become a source signal for generating various timing signals that are used by the banks to perform a read operation and a write operation.

The slave chip Slave0 may further include a timing signal is generating unit 300 configured to receive the bank enable signal AYP<0:3> and generate various timing signals that are used by the corresponding banks to perform read/write operations. In FIG. 1, the slave chip Slave0 is shown to include four timing signal generating units (i.e., first to fourth timing signal generating units) all of which are labeled with 300 to support the first to fourth banks The various timing signals may include a second timing signal YI, a third timing signal BWEN, a fourth timing signal IOSTBP, and fifth timing signal PIN. The second timing signal YI is activated when the bank performs a read or write operation. The second timing signal YI is used to control the electrical connection of a bit line (not illustrated) and a segment input/output line (not illustrated). The third timing signal BWEN is used to control the electrical connection of different input/output lines in a write operation. The fourth timing signal IOSTBP is used to control the electrical connection of different input/output lines in a read operation. The fifth timing signal PIN is outputted from the last terminal of the timing signal generating unit 300. The fifth timing signal PIN has synchronization information that is used by the slave chips Slave0˜Slave3 to transmit data to the master chip.

The slave chip Slave0 may further include a data application signal generating unit 400 configured to receive a bank address signal CBK<0:1> in response to the first reception signal Pre_AYP and the slice enable signal Son and generate a data application signal DATASTB<0:3> in response to the bank address signal CBK<0:1> and a sixth timing signal DATASTB. The data application signal

DATASTB<0:3> has four bits corresponding respectively to four banks. The data application signal DATASTB<0:3> is used to control the timing of electrically connecting a global input/output line GIO shared by all banks and a bank input/output lines BIO of each bank. Similar to the first reception signal Pre_AYP and the first timing signal AYP, the sixth timing signal DATASTB is generated by the master chip in response to a read command or a write command. Similar to the first reception signal Pre_AYP and the first timing signal AYP, the sixth timing signal DATASTB is transmitted in common to the slave chips Slave0˜Slave3 from the master chip through a TSV structure.

The stacked semiconductor memory apparatus utilizing a physical rank addressing (PRA) method would generate the bank enable signal AYP<0:3> by the slave chip Slave0 in response to the slice selection signal S<0:1>, the first reception signal Pre-AYP, and the first timing signal AYP. On the other hand, the stacked semiconductor memory apparatus utilizing a logical rank addressing (LRA) method utilize the bank enable signal AYP<0:3> generated by the master chip and transmits the bank enable signal AYP<0:3> to the slave chips Slave0˜Slave3 through four TSV structures. That is, in the stacked semiconductor memory apparatus using a logical rank addressing (LRA) method, the master chip distinguishes the banks to be enabled, rather than distinguishing the slave chips Slave0˜Slave3. This, for example, can support a 2-rank logical rank addressing (LRA) method and/or a 4-rank logical rank addressing (LRA) method, in is which a plurality of ranks are present in one slice (and it should be readily understood that the logical rank addressing (LRA) method according to an embodiment of the present invention may be designed to support more ranks). Unlike the stacked semiconductor memory apparatus using a logical rank addressing (LRA) method, the stacked semiconductor memory apparatus using a physical rank addressing (PRA) method shares the single-bit first timing signal AYP and the sixth timing signal DATASTB between the slave chips Slave0˜Slave3 and generates the bank enable signal AYP<0:3> and the data application signal DATASTB<0:3> by the slave chips Slave0˜Slave3. Therefore, the stacked semiconductor memory apparatus utilizing a physical rank addressing (PRA) method may be equipped with fewer TSV structures, which are necessary to select banks, than the stacked semiconductor memory apparatus using a logical rank addressing (LRA) method. This advantage increases with an increase in the number of banks per slice.

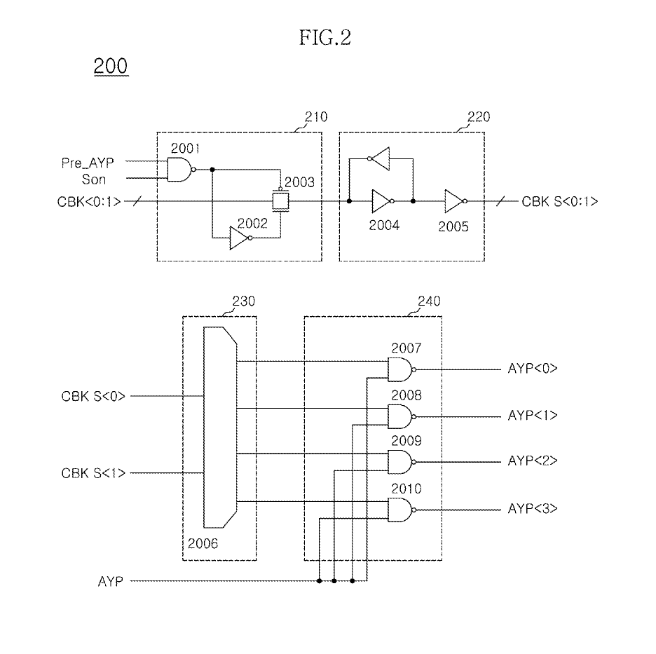

FIG. 2 is a circuit diagram of the bank selecting unit 200 illustrated in FIG. 1 according to an exemplary embodiment of the present invention.

Referring to FIG. 2, the bank selecting unit 200 may include a pass unit 210, a latch unit 220, a decoding unit 230, and a signal output unit 240.

The bank selecting unit 200 receives the bank address signal CBK<0:1> through the pass unit 210 and the latch unit 220 in response to the first reception signal Pre_AYP and the slice enable signal Son. Also, the bank selecting unit 200 generates the bank enable signal AYP<0:3> through the decoding unit 230 and the signal output unit 240 in response to the bank address signal CBK<0:1> and the first timing signal AYP.

The pass unit 210 passes the bank address signal CBK<0:1> in response to the slice enable signal Son and the first reception signal Pre_AYP. The pass unit 210 may include a NAND gate 2001, an inverter 2002, and a pass gate 2003. The NAND gate 2001 performs a NAND operation on the first reception signal Pre_AYP and the slice enable signal Son. The inverter 2002 inverts the output signal of the NAND gate 2001. The pass gate 2003 passes the bank address signal CBK<0:1> in response to the output signal of the inverter 2002 and the output signal of the NAND gate 2001. When both the slice enable signal Son and the first reception signal Pre_AYP are activated to a high level in the pass unit 210, the NAND gate 2001 outputs a low-level signal. Accordingly, the pass gate 2003 is enabled to pass the bank address signal CBK<0:1>.

The latch unit 220 latches the output signal of the pass unit 210 as a reception bank signal CBK S<0:1>. The latch unit 220 may include a latch circuit 2004 and an inverter 2005. The latch circuit 2004 latches the output signal of the pass gate 2003. The inverter 2005 inverts the output signal of the latch circuit 2004 to output the reception bank signal CBK S<0:1>.

The decoding unit 230 decodes the reception bank signal CBK S<0:1>. The decoding unit 230 may include a general decoder circuit 2006 configured to decode the reception bank signal CBK

S<0:1>. In FIG. 2, the bank address signal CBK<0:1> is illustrated as being a 2-bit signal, thus the reception bank signal CBK S<0:1> is also a 2-bit signal, and therefore the output signal of the decoder circuit 2006 is a 4-bit signal.

The signal output unit 240 generates the bank enable signal AYP<0:3> in response to the first timing signal AYP and the output signal of the decoding unit 230. The signal output unit 240 may include NAND gates 2007˜2010. The NAND gates 2007˜2010 are configured to perform a NAND operation on the first timing signal AYP and the 4-bit output signal of the decoding unit 230 and output the bank enable signal AYP<0:3>. Accordingly, when the first timing signal is activated to a high level, the signal output unit 240 inverts the output signal of the decoding unit 230.

The data application signal generating unit 400 shown in FIG. 1 may be configured in the same manner as the bank selecting unit 200 of FIG. 2. For the data application signal generating unit 400, the signal output unit 240 shown in FIG. 2 would instead be configured to receive the sixth timing signal DATASTB than the first timing signal AYP and then generate the data application signal DATASTB<0:3> instead of the bank enable signal AYP<0:3>. The other components and the signal input/output relationship of the data application signal generating unit 400 may be configured in the similar manner as those shown in FIG. 2.

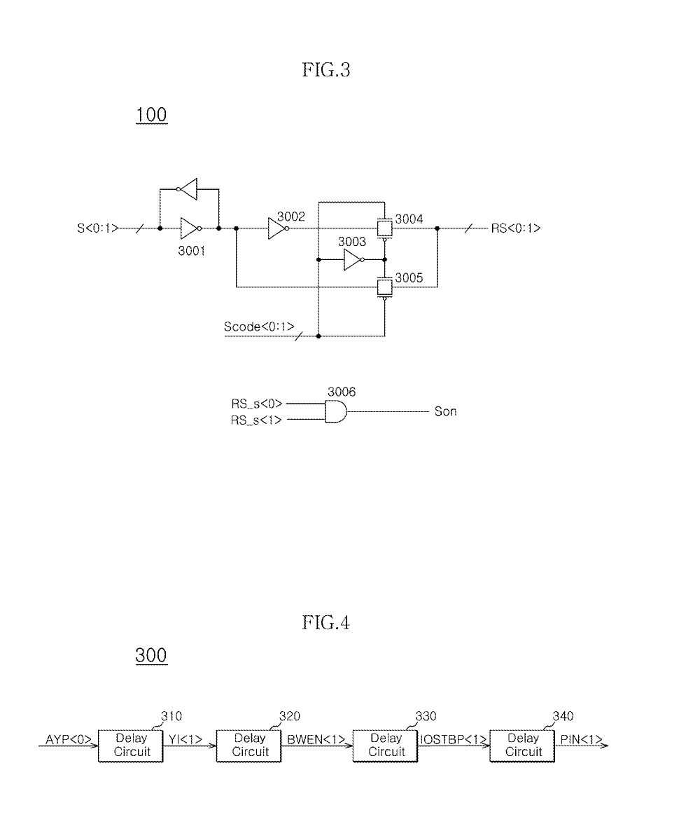

FIG. 3 is a circuit diagram of the slice determining unit 100 is according to an exemplary embodiment as illustrated in FIG. 1.

As described above with respect to FIG. 1, the slice determining unit 100 compares the slice selection signal S<0:1> and the allocated slice code Scode<0:1> and generate the slice enable signal Son. As illustrated in FIG. 3, the slice determining unit 100 may include a latch circuit 3001, inverters 3002 and 3003, pass gates 3004 and 3005, and an AND gate 3006. The latch circuit 3001 latches the slice selection signal S<0:1>. The inverter 3002 inverts the output signal of the latch circuit 3001. The inverter 3003 inverts the slice code Scode<0:1>. The pass gate 3004 passes the output signal of the inverter 3002 in response to the slice code Scode<0:1> and the output signal of the inverter 3003. The pass gate 3005 passes the output signal of the latch circuit 3001 in response to the slice code Scode<0:1> and the output signal of the inverter 3003. The output terminals of the pass gates 3004 and 3005 are connected to each other. The output signal of the pass gates 3004 and 3005 is referred to as a comparison result signal RS<0:1>. The AND gate 3006 performs an AND operation on the bits of the comparison result signal RS<0:1> to output the slice enable signal Son. Accordingly, the slice determining unit 100 activates the slice enable signal Son when the slice selection signal S<0:1> and the allocated slice code Scode<0:1> are identical to each other.

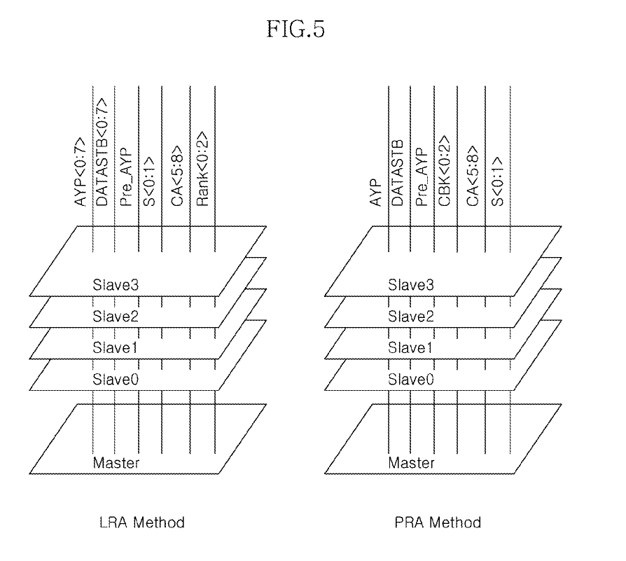

FIG. 4 is a block diagram of the timing signal generating unit 300 illustrated in FIG. 1 according to an exemplary embodiment of the present invention.

As described above, the timing signal generating unit 300 receives the bank enable signal AYP<0> and generates the second timing signal YI<1>, the third timing signal BWEN<1>, the fourth timing signal IOSTBP<1>, and the fifth timing signal PIN<1> that are various timing signals used by the bank to perform a read/write operation. As illustrated in FIG. 4, the timing signal generating unit 300 may include a plurality of delay circuits 310, 320, 330 and 340 connected in series to receive the bank enable signal AYP<0>, and may be configured to output the second timing signal YI<1>, the third timing signal BWEN<1>, the fourth timing signal IOSTBP<1>, and the fifth timing signal PIN<1>.

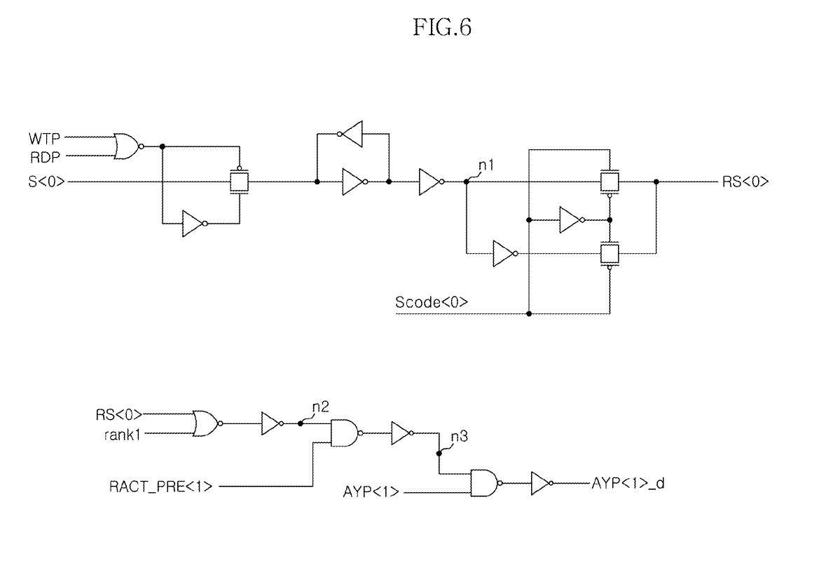

FIG. 5 is a diagram related to describing the signal transmission of a stacked semiconductor memory apparatus utilizing a logical rank addressing (LRA) method and the signal transmission of a stacked semiconductor memory apparatus utilizing a physical rank addressing (PRA) method.

Shown in FIG. 5 is a stacked semiconductor memory apparatus having a master chip Master and four slave chips Slave0˜Slave3 utilizing a 4-bank logical rank addressing (LRA) method, in which four ranks are located in each quadrant of the four slave chips. Each of the slave chips includes eight banks.

In the stacked semiconductor memory apparatus utilizing a logical rank addressing (LRA) method, the master chip Master transmits a 8-bit bank enable signal AYP<0:7>, which is a source signal used to generate various timing signals in a read or write operation, to the slave chips Slave0˜Slave3. Also, the master chip Master transmits a 8-bit data application signal DATASTB<0:7> that is used to control the timing of electrically connecting the global input/output line and the bank input/output line in a read or write operation. Also, the master chip Master transmits a 4-bit address signal CA<5:8> that is used to designate an address in a read or write operation of the bank. Also, the master chip Master transmits a 1-bit first reception signal Pre_AYP that is used to control the reception of the address signal CA<5:8> by the slave chips Slave0˜Slave3. Also, the master chip Master transmits a 3-bit rank selection signal Rank<0:2> that is used to select each quadrant (i.e., each rank) in an active operation and a precharge operation. Also, the master chip Master transmits a 2-bit slice selection signal S<0:1> that is used to select a desired chip. In this manner, the stacked semiconductor memory apparatus utilizing a logical rank (LRA) addressing method communicates the 3-bit bank address signal CBK<0:2>, the 8-bit bank enable signal AYP<0:7>, and the 8-bit data application signal DATASTB<0:7> through the TSV structure, in order to divide the banks in a read operation and a write operation.

In the stacked semiconductor memory apparatus utilizing a physical rank addressing (PRA) method, the master chip Master transmits a 1-bit timing signal AYP, which is a source signal used to generate various timing signals in a read or write operation, to the slave chips Slave0˜Slave3. Also, the master chip Master transmits a 1-bit sixth timing signal DATASTB that is a source signal used to generate a 8-bit data application signal DATASTB<0:7> that is used to control the timing of electrically connecting the global input/output line and the bank input/output line in a read or write operation. Also, the master chip Master transmits a 4-bit address signal CA<5:8> that is used to designate an address in a read or write operation of a selected bank. Also, the master chip Master transmits a 1-bit first reception signal Pre_AYP that is used to control the reception of the address signal CA<5:8> by the slave chips Slave0˜Slave3. Also, the first reception signal Pre_AYP may be used to control the timing of receiving the bank address signal CBK<0:2> in the physical rank addressing (PRA) method. Also, the master chip Master transmits a 3-bit bank address signal CBK<0:2> that is used to select one of the eight banks. Also, the master chip Master transmits a 2-bit slice selection signal S<0:1> that is used to select a desired chip. In this manner, the stacked semiconductor memory apparatus utilizing a physical rank addressing (PRA) method communicates the 3-bit bank address signal CBK<0:2>, the 1-bit timing signal AYP, and the 1-bit sixth timing signal DATASTB through the TSV structure, in order to distinguish the banks in a read operation and a write operation. That is, fewer TSV structures are needed in the stacked semiconductor memory apparatus utilizing a physical rank addressing (PRA) method, which are necessary to divide the banks, than the stacked semiconductor memory apparatus utilizing a logical rank addressing (LRA) method. This allows increased number of banks per slice. This advantage grows as there are more number of banks per slice (i.e., a is slave chip).

The stacked semiconductor memory apparatus using a physical rank addressing (PRA) method may operate in a read operation and a write operation as follows.

In a write operation of the stacked semiconductor memory apparatus utilizing a physical rank addressing (PRA) method, the master chip Master transmits data (not illustrated) to the slave chips Slave0˜Slave3. Thereafter, the slave chips Slave0˜Slave3 apply the data to the global input/output line. Thereafter, the master chip Master transmits the sixth timing signal DATASTB, the bank address signal CBK<0:2>, the first reception signal Pre_AYP, and the slice selection signal S<0:1> to the slave chips Slave0˜Slave3. Thereafter, the slave chips Slave0˜Slave3 generate the slice enable signal Son in response to the slice selection signal S<0:1> and generate the data application signal DATASTB<0:7> in response to the slice enable signal Son, the sixth timing signal DATASTB, and the bank address signal CBK<0:2>. Thereafter, in response to the data application signal DATASTB<0:7>, the slave chips Slave0˜Slave3 transmit the data, applied to the global input/output line, to the bank input/output line. Thereafter, in response to the slice enable signal Son and the first reception signal Pre_AYP, the slave chips

Slave0˜Slave3 receive the bank address signal CBK<0:2> and generate the reception bank signal CBK S<0:2>. Thereafter, the master chip Master transmits the first timing signal AYP to the slave chips Slave0˜Slave3. The slave chips Slave0˜Slave3 generate the bank enable signal AYP<0:7> in response to the first timing signal AYP and the reception bank signal SBK S<0:2>. In response to the bank enable signal AYP<0:7>, the slave chips Slave0˜Slave3 generate various timing signals (e.g., the third timing signal BWEN) necessary for the write operation. In response to the third timing signal BWEN, the slave chips Slave0˜Slave3 apply the data, applied to the bank input/output line, to a local input/output line. The slave chips Slave0˜Slave3 write the data, applied to the local input/output line, in the bank with the activated bank enable signal AYP<0:7> of the slave chip with the activated slice enable signal Son.

In a read operation of the stacked semiconductor memory apparatus utilizing a physical rank addressing (PRA) method, the master chip Master transmits the sixth timing signal DATASTB, the bank address signal CBK<0:2>, the first reception signal Pre_AYP, and the slice selection signal S<0:1> to the slave chips Slave0˜Slave3. Thereafter, the slave chips Slave0˜Slave3 generate the slice enable signal Son in response to the slice selection signal S<0:1> and generate the data application signal DATASTB<0:7> in response to the slice enable signal Son, the sixth timing signal DATASTB, and the bank address signal CBK<0:2>. Thereafter, in response to the slice enable signal Son and the first reception signal Pre_AYP, the slave chips Slave0˜Slave3 receive the bank address signal CBK<0:2> and generate the reception bank signal CBK S<0:2>. Thereafter, the master chip Master transmits the first timing signal AYP to the slave chips Slave0˜Slave3. The slave chips Slave0˜Slave3 generate the bank enable signal AYP<0:7> in response to the first timing signal AYP and the reception bank signal SBK S<0:2>. In response to the bank enable signal AYP<0:7>, the slave chips Slave0˜Slave3 generate various timing signals (e.g., the fourth timing signal IOSTBP) necessary for the read operation. The slave chips Slave0˜Slave3 read data written in the bank with the activated bank enable signal AYP<0:7> of the slave chip with the activated slice enable signal Son, and apply the read data to the local input/output line. Thereafter, in response to the fourth timing signal IOSTBP, the slave chips Slave0˜Slave3 apply the data, applied to the local input/output line, to the bank input/output line. Thereafter, in response to the data application signal DATASBP<0:7>, the slave chips Slave0˜Slave3 transmit the data, applied to the bank input/output line, to the global input/output line. Thereafter, the slave chips Slave0˜Slave3 transmit the data, applied to the global input/output line, to the master chip Master.

Regarding the input/output lines used in the write operation and the read operation, the global input/output line is shared between a plurality of banks included in each slave chip (e.g., Slave0). The bank input/output line is present in each bank, and is electrically connected between the global input/output line and the local input/output line. The local input/output line is electrically connected between the bank input/output line and the segment input/output line, and the segment input/output line is electrically connected between the local input/output line and the bit line. In the write operation, the bank input/output line is electrically connected to the global input/output line in response to the data application signal DATASTB<0:7>. Also, the local input/output line is electrically connected to the bank input/output line in response to the third timing signal BWEN. In the read operation, the local input/output line is electrically connected to the bank input/output line in response to the fourth timing signal IOSTBP. Also, the global input/output line is electrically connected to the global input/output line in response to the data application signal DATASTB<0:7>. The input/output lines and the timing signals may be set differently according to embodiments. It should be readily understood that the above-described input/output lines and timing signals according to an embodiment of the present invention are not intended to limit the overall scope of the present invention.

The stacked semiconductor memory apparatus utilizing a physical rank addressing (PRA) method exhibits better tAA characteristics, that is, the period of time from a read command to the output of data to a data pad, than the stacked semiconductor memory apparatus utilizing a logical rank addressing (LRA) method. In order to generate the bank enable signal AYP<0:3>, the stacked semiconductor memory apparatus utilizing a logical rank addressing (LRA) method should detect or verify beforehand how many ranks are utilized in the logical rank addressing (LRA) method. However, since one slice constitutes one rank in a physical rank addressing (PRA) method, the stacked semiconductor memory apparatus using the PRA is method need not perform the rank detection operation that is required in the stacked semiconductor memory apparatus utilizing a logical rank addressing (LRA) method. The rank detection operation will be described below in more detail with reference to FIG. 6.

Referring to FIG. 2, in the bank selecting unit 200 of the stacked semiconductor memory apparatus utilizing a physical rank addressing (PRA) method, five-stage logic devices (i.e., a pass gate, two inverters, a decoder circuit, and a NAND gate) are required from the point of receiving the bank address signal CBK<0:1> to the point of generating the bank enable signal AYP<0:3>.

FIG. 6 is a circuit diagram for a rank detecting operation of a stacked semiconductor memory apparatus utilizing a logical rank addressing (LRA) method in accordance with an embodiment of the present invention. The rank detecting circuit in FIG. 6 is illustrated for use in a stacked semiconductor memory apparatus having a master chip and two slave chips, but it should be readily understood that more than two slices are possible without departing the scope and spirit of the present invention. To distinguish two slave chips, a one bit signal, i.e., a slave selection signal S<0>, would be needed.

Referring to FIG. 6, the stacked semiconductor memory apparatus utilizing a logical rank addressing (LRA) method operates as follows. When a read pulse signal RDP or a write pulse signal WDP is activated in response to a read or write command, the slice selection signal S<0> is received and is latched at a first node n1. Thereafter, the logic value of the first node n1 and the slice code Scode<0> are compared, and a comparison result signal RS<0> is generated. The comparison result signal RS<0> is NOR-operated with a first rank signal rank1. The first rank signal rank1 is activated when the stacked semiconductor memory apparatus uses a 1-rank logical rank addressing (LRA) method. When the comparison result signal RS<0> or the first rank signal rank1 is activated, a second node n2 becomes a high level. The voltage level of the second node n2 is NAND-operated with a pre-detection signal RACT_PRE<1>. The pre-detection signal RACT_PRE<1> is present in each bank, and it is illustrated that the pre-detection signal RACT_PRE<1> corresponds to first bank. The pre-detection signal RACT_PRE<1> is activated according to whether an active operation is performed by the first bank. When both the second node n2 and the pre-detection signal RACT_PRE<1> are activated, a third node n3 is activated. The voltage level of the third node n3 is NAND-operated with the bank enable signal AYP<1>. The bank enable signal AYP<1> corresponds to the first bank. When both the third node n3 and the bank enable signal AYP<1> are activated, the bank enable signal AYP<1> _d of the first bank is activated. Referring to FIG. 6, ten-stage logic devices (i.e., two pass gates, four inverters, a latch circuit, and two NAND gates) are required from the time point of receiving the slice selection signal S<0> to the time point of generating the bank enable signal AYP<1> _d. In this manner, the stacked semiconductor memory apparatus utilizing a physical rank addressing (PRA) method has better tAA characteristics than the stacked semiconductor memory apparatus utilizing a logical rank addressing (LRA) method.

While certain embodiments have been described above, it will be understood to those skilled in the art that the embodiments described are by way of example only. Accordingly, the apparatus and method described herein should not be limited based on the described embodiments. Rather, the apparatus and method described herein should only be limited in light of the claims that follow when taken in conjunction with the above description and accompanying drawings.

What is claimed is:

1. A semiconductor memory apparatus comprising:
a master chip configured to output a first reception signal, a first timing signal, a bank address signal, and a slice selection signal; and
a plurality of slave chips, each slave chip having a plurality of banks comprising:
a slice determining unit configured to compare the slice selection signal and a slice code and generate a slice enable signal; and
a bank selecting unit configured to receive the bank address signal in response to the first reception signal and the slice enable signal and generate a bank enable signal in response to the bank is address signal and the first timing signal.

2. The semiconductor memory apparatus according to claim 1, wherein the bank selecting unit comprises:
a pass unit configured to pass the bank address signal in response to the slice selection signal and the first reception signal; and
a latch unit configured to latch an output signal of the pass unit.

3. The semiconductor memory apparatus according to claim 2, wherein the bank selecting unit further comprises:
a decoding unit configured to decode an output signal of the latch unit; and
a signal output unit configured to generate the bank enable signal in response to the first timing signal and an output signal of the decoding unit.

4. The semiconductor memory apparatus according to claim 1, wherein the first timing signal is a single-bit signal transmitted in common to the slave chips.

5. The semiconductor memory apparatus according to claim 4, wherein when a read command or a write command is activated, the master chip generates the first reception signal after a first is predetermined time and generates the first timing signal after a second predetermined time.

6. The semiconductor memory apparatus according to claim 1, wherein the master chip further provides an address signal to the slave chips, and the slave chips receive the address signal in response to the first reception signal.

7. The semiconductor memory apparatus according to claim 1, wherein the master chip further provides a sixth timing signal to the slave chips, and the slave chips electrically connect a first input/output line and a second input/output line in response to the sixth timing signal.

8. The semiconductor memory apparatus according to claim 7, wherein the sixth timing signal is a single-bit signal transmitted in common to the slave chips.

9. The semiconductor memory apparatus according to claim 1, wherein the slave chips further comprise a timing signal generating unit configured to generate a second timing signal, a third timing signal, a fourth timing signal, and a fifth timing signal in response to the bank enable signal.

10. The semiconductor memory apparatus according to claim 1, wherein the master chip and the slave chips are stacked and are electrically connected through a through-silicon via (TSV) structure.

11. A method for operating a semiconductor memory apparatus comprising a master chip and a plurality of chips, the method comprising the steps of:
applying a slice selection signal and a first reception signal to the slave chips;
generating an activated slice enable signal by one of the slave chips by comparing the slice selection signal and each slice code;
providing a bank address signal and generating a reception bank signal in response to the first reception signal to the chip with the slice enable signal activated;
applying a first timing signal to the slave chips; and
selecting one of a plurality of banks of the slave chip according to the reception bank signal and the first timing signal.

12. The method according to claim 11, wherein the first timing signal is a single-bit signal transmitted in common to the slave chips.

13. The method according to claim 12, further comprising the step of providing the first reception signal and the first timing signal in response to a read command or a write command.

14. The method according to claim 11, further comprising the steps of:
applying a sixth timing signal to the slave chips; and
electrically connecting a first input/output line and a second input/output line of the slave chip in response to the sixth timing signal.

15. The method according to claim 14, further comprising the steps of:
applying data to the slave chips;
transmitting the data from the slave chips to the first input/output line; and
writing data, applied to the second input/output line, into the selected bank.

16. The method according to claim 14, further comprising the steps of:
reading data written in the selected bank from the slave chips;
applying the read data from the slave chips to the second input/output line; and
transmitting data, applied to the first input/output line, from the slave chips to the master chip.

17. The method according to claim 14, wherein the sixth timing signal is a single-bit signal transmitted in common to the slave chips.

18. The method according to claim 14, wherein the master chip and the slave chips are stacked and are electrically connected through a through-silicon via (TSV) structure.

19. The method according to claim 18, wherein the slice selection signal, the first reception signal, the first timing signal, and the sixth timing signals are outputted from the master chip.
